(19) United States
(12) Patent Application Publication
(10) Pub. No.: US 2006/0144260 A1
(43) Pub. Date: Jul. 6, 2006

(54) Mail distribution methods and apparatus

(76) Inventors: Gregory L. Foutz, Mesa, AZ (US); Robert Rinard, Phoenix, AZ (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/027,707

(22) Filed: Dec. 31, 2004

(51) Int. Cl. B41F 17/00

(52) U.S. Cl. 101/35; 209/900; 705/1; 270/32; 493/187; 705/401

(57) ABSTRACT

A method, according to an embodiment, includes executing a print-mail application, on a client device, to perform a print-mail process for a printable item that is selectable by the client device. A user of the client device is prompted for client-specified print-mail information, which includes recipient address information. An electronic version of the printable item and the client-specified print-mail information are sent over a network to a receiving center. The receiving center determines one or more destination print distribution centers based on the recipient address information. The receiving center sends the electronic version of the printable item to the one or more destination print distribution centers. A destination print distribution center prints a copy of the printable item. In an embodiment, the copy is inserted into an envelope for mailing to a physical recipient address.

### BACKGROUND

Each year, individuals and businesses send hundreds of billions of letters through physical mail systems, such as government-owned systems (e.g., the United States Postal Service) and privately-owned systems (e.g., UPS and Federal Express). For many years, these physical mail systems have used similar processes to get a letter from point A to point B.

These processes include at least the following steps: 1) a letter is received at a collection/sorting facility (e.g., a U.S. Post Office or a private letter carrier facility); 2) the letter is subjected to a sorting process, according to its destination address; 3) if the letter is not destined for a local address, then the letter is transported over a transportation channel (e.g., including trucks, airplanes, trains, etc.) to a collection/sorting facility nearer to the destination address; and 4) the letter is hand-carried to the destination address.

Each of the process steps takes time. Some processes may take minutes (e.g., if machines are used to perform sorting), and some processes may take days or weeks (e.g., if a letter is sent from one country to another). In addition, the mailing process may be very expensive. For example, a letter mailed to a foreign country may require substantially more postage than a letter mailed across town. In a world that desires faster and less expensive communication methods, traditional methods of mail delivery have become increasingly intolerable.

### BRIEF DESCRIPTION OF THE DRAWINGS

Like-reference numbers refer to similar items throughout the figures and:

FIG. 1 is a simplified block diagram of a mail distribution system, in accordance with an example embodiment;

FIG. 2 is a simplified block diagram of a receiving center, in accordance with an example embodiment;

FIG. 3 is a simplified block diagram of a print distribution center, in accordance with an example embodiment;

FIG. 4 is a flowchart of a method for establishing a system account, in accordance with an example embodiment;

FIG. 5 is a flowchart of a method for logging into an account and downloading a print-mail application, in accordance with an example embodiment;

FIG. 6 is a flowchart of a method for sending a printable item through a mail distribution system, in accordance with an example embodiment;

FIG. 7 is an example of a print window, which enables a user to select a print-mail application, in accordance with an example embodiment;

FIG. 8 is an example of a display window, which enables a user to specify one or multiple destination addresses, in accordance with an example embodiment;

FIG. 9 is an example of a display window, which enables a user to login and to specify a return address, in accordance with an example embodiment;

FIG. 10 illustrates a document queue 1000, in accordance with an example embodiment;

FIG. 11 is an example of a printed address cover sheet, in accordance with an example embodiment; and

FIG. 12 is an example of a ready-to-mail letter, in accordance with an example embodiment.

### DETAILED DESCRIPTION

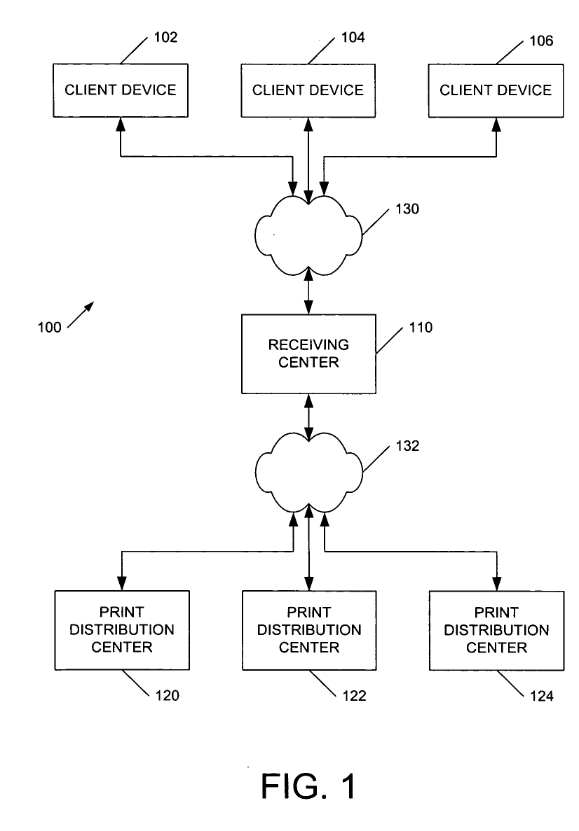

FIG. 1 is a simplified block diagram of a mail distribution system 100, in accordance with an example embodiment. System 100 includes one or more client devices 102, 104, 106, one or more receiving centers 110, and one or more print distribution centers 120, 122, 124.

In an embodiment, a user of a client device 102, 104, 106 may indicate that the user wishes to “print-mail” a printable item (e.g., a document, image and/or text) that is displayed by, stored on, or accessible to the device 102, 104, 106. The term “print-mail,” as used herein, means to cause an electronic version of a printable item to be routed from a source computer to a destination computer, a hard-copy of the printable item to be printed, and the hard-copy to be inserted into an envelope, and the resulting letter to be physically delivered to a recipient address. The term “letter,” as used herein, means an envelope that displays a recipient address and that includes a hard-copy of a printable item.

In an embodiment, the client device 102, 104, 106 may prompt the user for one or more addresses, delivery parameters, printing parameters, and/or other information. The client device 102, 104, 106 may then send the addresses, delivery parameters, printing parameters, and/or other information (referred to herein as “client-specified print-mail information”), along with an electronic version of the printable item, to a receiving center 110 (e.g., over network 130).

In an embodiment, receiving center 110 may then determine one or more destination print distribution centers 120, 122, 124, based on the recipient address or addresses, among other things. The receiving center 110 sends an electronic version of the printable item and printing/delivery information to the destination print distribution center or centers 120, 122, 124 (e.g., over network 132).

The electronic version of the printable item, which the receiving center 110 sends to a destination print distribution center 120, 122, 124, may or may not be in the same format as the electronic version that the receiving center 110 received from the client device 102, 104, 106. In other words, the receiving center 110 may reformat and/or repackage the electronic version of the printable item prior to sending it to a destination print distribution center 120, 122, 124. Further, the receiving center 110 may add to, modify, delete from, reformat, and/or repackage all or portions of the client-specified print-mail information to produce the printing/delivery information, which the receiving center 110 sends to a destination print distribution center 120, 122, 124.

A selected print distribution center 120, 122, 124 may then print a return address and/or the recipient address onto an address cover sheet and/or onto an envelope, and may also print a copy of the printable item. In an embodiment, the selected print distribution center 120, 122, 124 also may insert the address cover sheet (if any) and the printable item copy into the envelope, and further may apply an appropriate amount of postage to the envelope. The resulting letter is then made available for physical delivery by a locally available letter carrier.

Embodiments will be described below in further detail. It will be apparent, based on the description herein, that various embodiments may have one or more distinctive features over traditional document delivery services. For example, one or more of the following distinctions may exist: 1) Convenience: A user may achieve hand-delivery of a hard copy of a printable item without personally printing the hard copy, preparing the envelope, applying postage, or carrying the letter to a collection site; 2) Speed: A hard copy of a printable item may be delivered to a recipient address in another mailing region (e.g., another state or country) very quickly, by eliminating a transport delay between the source mailing region and the recipient mailing region; and 3) Expense Reduction: A hard copy of a printable item may be delivered to a recipient address in a remote mailing region (e.g., another country) using only local postage for the recipient mailing region.

Referring again to FIG. 1, each system component will now be described in greater detail. In an embodiment, a user may initiate a print-mail process through interaction with a client device 102, 104, 106. Although three client devices 102, 104, 106 are illustrated in FIG. 1, a system may have more or fewer client devices, and the number of client devices may change over time. A client device 102, 104, 106 may include, for example, a personal computer, a laptop computer, a personal data assistant (PDA), a pager, or another device capable of displaying text and communicating over a wired or wireless connection.

In an embodiment, a client device 102, 104, 106 includes one or more processors, data storage, and a user interface. The user interface enables a user to specify a printable item (e.g., a document, text block, image, graphics, or other object) that the user wishes to print-mail. A user interface may include, for example, a display screen and a keyboard.

Once a printable item has been identified, and a print-mail option selected, a client device 102, 104, 106 may send an electronic version of the printable item to one or more receiving centers 110. In addition, a client device 102, 104, 106 may send other client-specified print-mail information, which a receiving center 110 may use to determine a destination print distribution center 120, 122, 124, and which the destination print distribution center 120, 122, 124 may use to determine how to print and deliver the electronic version of the printable item.

A client device 102, 104, 106 may communicate with the one or more receiving centers 110 over one or more networks (e.g., network 130) and/or dedicated links. In various embodiments, network 130 may include a local area network (LAN), a wide area network (WAN), the internet, and any number of routers, repeaters, relays or other intermediate nodes. Further, a client device 102, 104, 106 may communicate over a wired or wireless link with network 130.

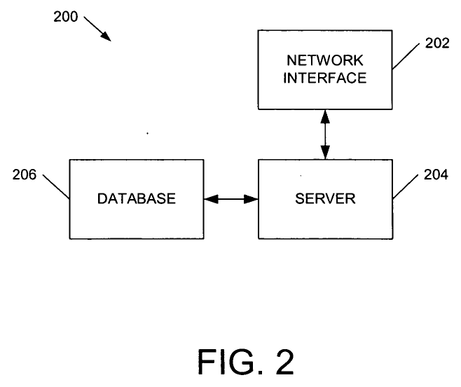

Receiving center 110 may include one or more servers and/or other computing apparatus. Although one receiving center 110 is illustrated in FIG. 1, a system may have multiple receiving centers. FIG. 2 is a simplified block diagram of a receiving center 200, in accordance with an example embodiment. Receiving center 200 includes one or more network interfaces 202, one or more servers 204, and a database 206, in an embodiment. Network interface 202 enables receiving center 200 to receive and send messages over a network (e.g., a LAN or WAN). Server 204 includes one or more processors, which enable receiving center 200 to generate and process messages, determine job routing, and store/retrieve information to/from database 206. In an embodiment, database 206 may store account information for the print-mail system, among other things.

Referring again to FIG. 1, receiving center 110 may send an electronic version of the printable item (in the same or a different format), along with printing/delivery information, to one or more print distribution centers 120, 122, 124. Although three print distribution centers 120, 122, 124 are illustrated in FIG. 1, a system may have more or fewer centers.

A receiving center 110 may communicate with the one or more print distribution centers 120, 122, 124 over one or more networks (e.g., network 132) and/or dedicated links. In various embodiments, network 132 may include a LAN, a WAN, the internet, and any number of routers, repeaters, relays or other intermediate nodes. Further, a receiving center 110 and/or a print distribution center 120, 122, 124 may communicate over a wired or wireless link with network 132.

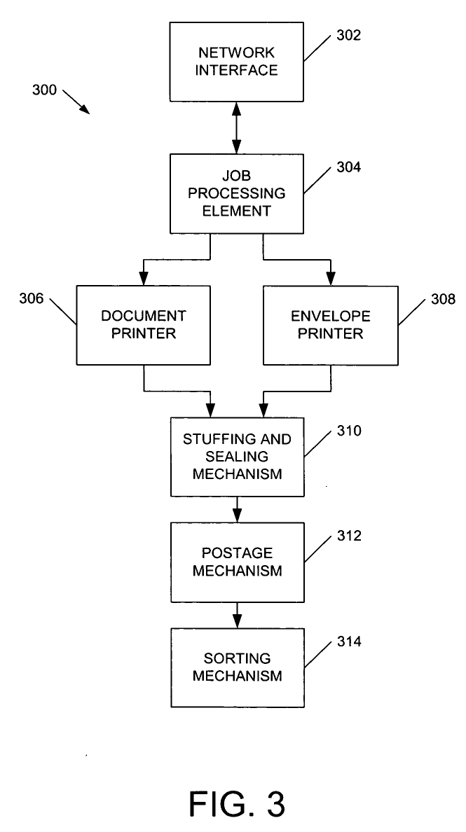

FIG. 3 is a simplified block diagram of a print distribution center 300, in accordance with an example embodiment. In an embodiment, print distribution center 300 includes a network interface 302, a job processing element 304, and one or more printers 306, 308. Print distribution center 300 may further include an envelope stuffing and sealing mechanism 310, a postage mechanism 312, and a sorting mechanism 314, in an embodiment.

Network interface 302 enables print distribution center 300 to receive and send messages over a network (e.g., a LAN or WAN). For example, print distribution center 300 may receive an electronic version of a printable item and printing/distribution information via network interface 302. Job processing element 304 may include one or more processors, which determine how to execute a print job, based on the received printing/distribution information for a job. This may include, for example, determining how to print a printable item, how to print an address cover sheet (if any), and determining how to print an envelope (if one is printed).

In an embodiment, job processing element 304 sends data and control information to document printer 306, which prints out a printable item. Document printer 306 may additionally print out an address cover sheet, if necessary, and may include a collation mechanism to collate the address cover sheet and the copy of the printable item. In another embodiment, a collation mechanism that is distinct from the printer 306 may be included in the system. In addition, in an embodiment, job processing element 304 may send data and control information to envelope printer 308, which may print one or more addresses or other information onto an envelope.

Envelope stuffing and sealing mechanism 310 may receive an envelope, a printed document, and an address cover sheet (if any). Mechanism 310 may cause the document and cover sheet to be folded, if appropriate for the envelope, inserted into the envelope, and the envelope to be sealed, in an embodiment.

Postage mechanism 312 may include a weighing device, a postage determination processor, and a postage printer, in an embodiment. Accordingly, when a letter has been sealed within an envelope, it may be weighed, the appropriate postage determined, and the appropriate postage applied to the envelope. Finally, a sorting mechanism 314 may sort the letter into an appropriate bin, in an embodiment.

A mail distribution system, according to various embodiments, may be operated as a not-for-profit or a for-profit entity. For example, a not-for-profit entity may be a company, for example, that implements the system internally to save time and money associated with the company's mailings. A for-profit entity may allow users to access the system infrastructure and mail printable items for a fee. In one such embodiment, a user may be prompted by the system for payment (e.g., via credit card) each time the user print-mails a printable item. In another embodiment, the system may ask an entity and/or users to establish an account prior to use, and the system may maintain information that enables the system to determine billings for the account.

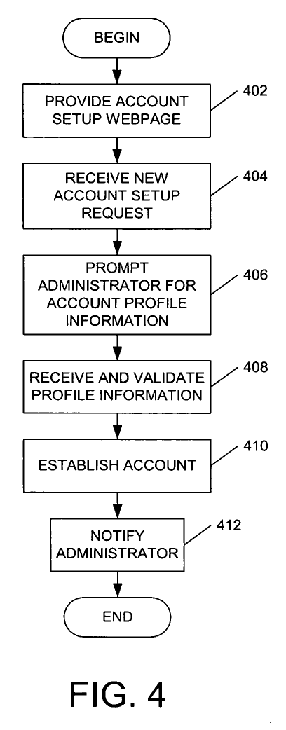

FIG. 4 is a flowchart of a method for establishing a system account, in accordance with an example embodiment. An account may be established for a single user or for a group of users, in various embodiments. For example, a company may want to establish an account, which multiple authorized users (e.g., employees) may access. Accordingly, a single account may be billed each time any one of a group of authorized users performs a print-mail transaction using the system.

In an embodiment, an account may be established over a network (e.g., over the internet) by accessing a webpage or another account setup tool. An internet-based account setup embodiment is described below. It would be apparent to one of skill in the art, based on the description herein, that other ways of establishing an account may be used in alternate embodiments.

A method for establishing a system account may begin, in block 402, by a server providing an account setup webpage in response to a page request from a client device (e.g., devices 102, 104, 106, FIG. 1). In an embodiment, the account setup server may be associated with a receiving center (e.g., receiving center 110, FIG. 1). Alternatively, a distinct server may be used for account setup. For purposes of clarity, the individual who manipulates the client device to establish an account is referred to herein as an “administrator.”

In block 404, the server may receive a message indicating that the administrator requests set up of a new account. For example, via a user interface on the client device, an administrator may select a webpage element that causes an account setup request message to be sent to the server.

In block 406, the server may then prompt the administrator for account profile information, by providing an additional webpage that includes profile information entry elements. Profile information may include, for example, the name of the account owner (e.g., a company or individual), the names of one or more users who will be authorized to incur charges for the account through system use, password information, payment information (e.g., credit card information), billing information (e.g., billing name and address), contact information, and the like.

In block 408, the server may receive and validate the profile information provided by the client device. For example, the server may determine whether all mandatory information was provided. The server may also validate addresses (e.g., are they within recognized ranges), payment information, and other client-provided profile information. If all mandatory information was not provided or other portions of the client-provided profile information are not valid, the server may send a notice to the client device, and further prompt the administrator to provide valid information.

When the profile information has been validated, the server may establish an account, in block 410. This may include designating resources to the account, establishing an account identifier (ID), and enabling the administrator to identify one or more authorized users and set passwords for those users. In an embodiment, a user may be identified by a “username.” Usernames and/or passwords may be established later, as well (e.g., a new user may be added to an account after the account has already been established for some time).

In an embodiment, account resources may include a designated block or quantity of memory within which account-related information may be stored. In an embodiment, account-related information is stored and maintained in an “account information database,” which is accessible to the system. Account-related information may include, for example, an account ID, account owner information, authorized user information (e.g., usernames and passwords), and billing information, among other things. When an account has been successfully established, the server may send a message to that effect to the client, in block 412. The method then ends.

Once an account is established, an authorized user (e.g., a user with a valid username and password) may login to the system, and may perform one or more actions. For example, but not by way of limitation, access to an account may enable a user to print-mail printable items, view and/or modify account information (e.g., current or past billing information, authorized users, access privileges, entity information, etc.), download applications, and electronically post payments to the account, among other things.

For example, in an embodiment, an authorized user may be given the opportunity to download a “print-mail application” from the server to a client device. In an embodiment, a “print-mail application” includes a software program, which enables a user of a client device to print-mail a printable item using the print-mail system. In an embodiment, a print-mail application includes a printer driver. In other embodiments, a print-mail application may include other types of software programs.

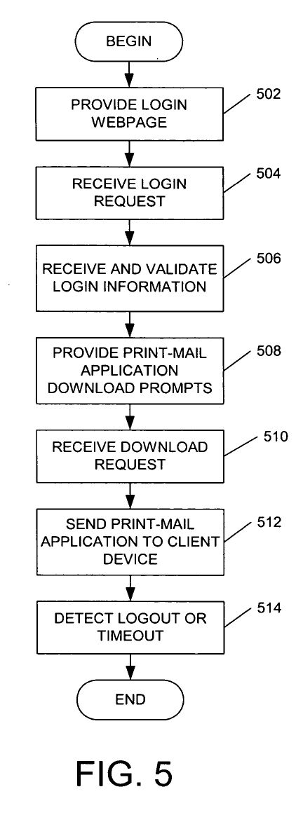

FIG. 5 is a flowchart of a method for logging into an account and downloading a print-mail application, in accordance with an example embodiment. The method begins, in block 502, by a server providing a “login” webpage (i.e., a webpage that includes login elements) in response to a page request from a client device (e.g., devices 102, 104, 106, FIG. 1). In an embodiment, the server may be associated with a receiving center (e.g., receiving center 110, FIG. 1). Alternatively, a different server may be used to enable access to the system.

In block 504, the server may receive a message indicating that the user requests to log in. For example, via a user interface on the client device, a user may enter a username and a password into respective login page elements. A user also may be prompted for an account ID, in an embodiment. A user may then select a “Login” element, or press the enter key, to cause the client device to send a login request message to the server.

In block 506, the server receives the message and determines if the account ID (if provided), username, and password are valid, by correlating the client-provided account ID, username, and password with valid account IDs, usernames, and passwords in the account information database. If one or more of the account ID, username or password are not valid, then the server sends a message to the client device, indicating an unsuccessful login attempt, and the procedure iterates as shown. The server may allow the user to make a limited number of unsuccessful login attempts, and then may block the client device from attempting to login (e.g., by temporarily disabling access to an account, or by temporarily disallowing login requests from the particular client device).

If the account ID, username, and password are valid, then in block 508, the server provides account access. As mentioned previously, in an embodiment, access to an account may enable a user to perform one or more of a set of actions, including but not limited to, print-mailing printable items, viewing and/or modifying account information, downloading applications, and electronically posting payments to the account, among other things.

Each valid username may be associated with a set of account access privileges. For example, a first username may have the privilege to modify account information, while a second username may not. For another example, a user who has the privilege to print-mail a printable item may also have the privilege to download a “print-mail application” from the server. A user may perform other actions, as well, but those actions are not illustrated or described herein for the purpose of conciseness. It would be apparent to one of skill in the art, based on the description herein, how to modify the flowchart of FIG. 5 to include processes for performing other actions.

In an embodiment, a print-mail application includes a printer driver (referred to herein as a “print-mail printer driver”), which may be installed on the client device. After installation, the print-mail printer driver may be initiated to print-mail a printable item, as will be described later. In another embodiment, a print-mail application and/or print-mail printer driver may be installed on a client device in a manner other than by download from a remote server or other device. For example, but not by way of limitation, a print-mail application may be installed by a client device manufacturer, or a print-mail application may be stored on a removable storage medium (e.g., a compact disk, floppy disk, memory card, memory stick, or the like), and installed by a user after inserting or otherwise connecting the storage medium to the client device.

In block 508, the server provides prompts to enable a logged-in user, with appropriate access privileges, to download a print-mail application. When the server receives a request, in block 510, from the client device to download the print-mail application, then the server sends the application to the client device, in block 512. Eventually, the server may determine, in block 514, that the user has logged out (e.g., after receiving a logout request message from the client device), or the session may timeout. At that time, the method ends.

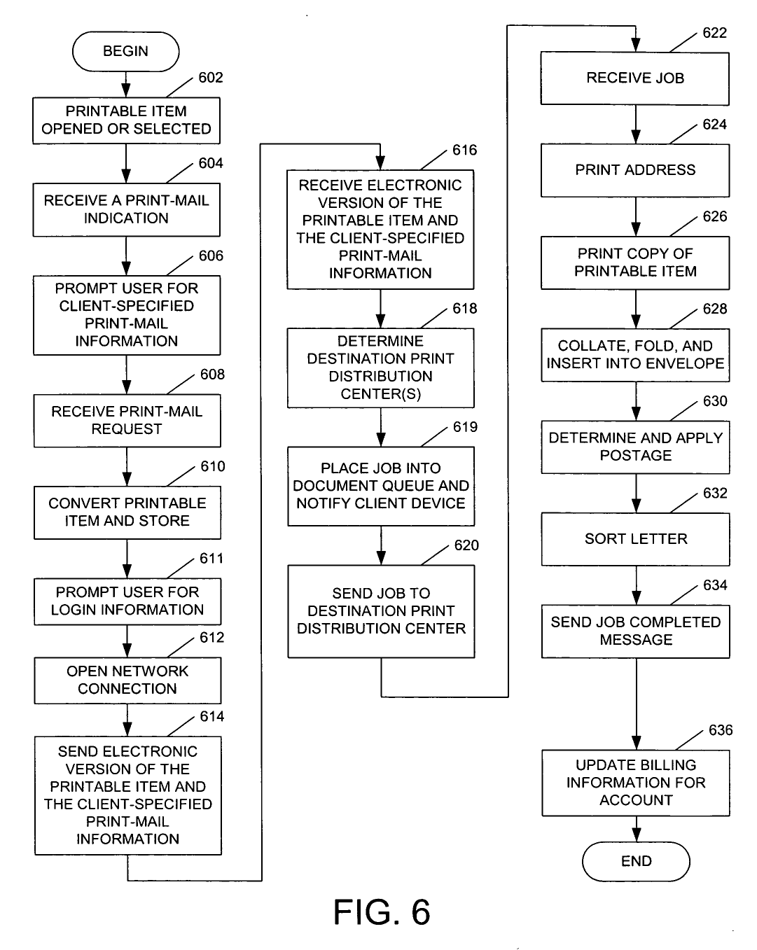

FIG. 6 is a flowchart of a method for sending a printable item through a mail distribution system, in accordance with an example embodiment. The method may begin, in block 602, when a user at a client device has opened or selected a printable item on the client device. A printable item may include, for example, all or a portion of an application-created document (e.g., a word processor generated document, a spreadsheet, an electronic presentation, an image file, a computer automated design file, and the like), an email message, a webpage, or virtually any other electronic text, image, graphics, or combination thereof, which can be opened and/or displayed on a client device. A user may “open” a printable item, for example, using a software application that created or can open the object. For example, if a printable item includes a Microsoft Word file, then a user may open the file using the Microsoft Word software application. A user may “select” a printable item, for example, by using a cursor to highlight the object (e.g., a filename or an email) in a folder or list or by selecting a portion of an object (e.g., a block of text within a document).

In block 604, the client device may receive an indication that the user wishes to print-mail the selected printable item. In an embodiment, a user may produce this indication by selecting a “Print” option within an open application or from a window task bar. This causes the client device to prompt the user, in block 606 for client-specified print-mail information (e.g., printing options, login information, delivery information, etc.), in an embodiment.

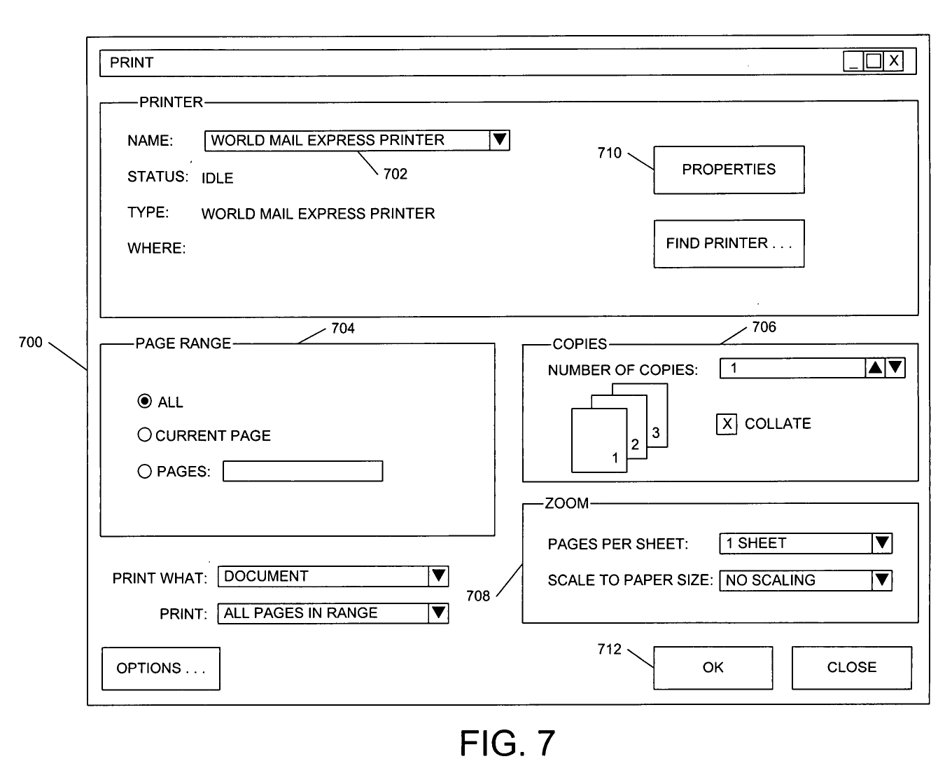

A user may be prompted for this information using a series of one or more windows, in an embodiment. FIGS. 7-9 illustrate three example windows for prompting a user for client-specified print-mail information. It would be apparent to one of skill in the art that more or fewer windows may be used to prompt the user for this information, the various portions of information may appear in different combinations on different pages, and more, fewer or different information prompts may be provided on the various pages. Accordingly, it is to be understood that the example windows in FIGS. 7-9 are for the purposes of illustration, and not of limitation.

In an embodiment, when a user selects a “Print” option (e.g., from a toolbar or using a series of keystrokes (e.g., “Ctrl” and “p”)), an application corresponding to the type of selected document or text may cause a “Print” window to appear. FIG. 7 is an example of a print window 700, which enables a user to select a print-mail application, in accordance with an example embodiment. In an embodiment, when a print-mail application is installed on the client device, it includes a printer driver. Accordingly, a print-mail printer, which corresponds to the print-mail printer driver, may be included in a list (e.g., a drop-down list) of available printers. A print-mail printer is named “World Mail Express Printer,” in the example printer selection element 702. When a user selects the print-mail printer, then the print-mail printer driver will be used to print-mail the selected printable item.

A user may be able to specify other information through interaction with the print window, as well. For example, but not by way of limitation, a print window may include options 704 to enable a user to select “all pages”, a “current page,” or selected pages of a printable item. In an embodiment, only the selected page or pages are print-mailed. A print window may additionally include an option 706 to enable a user to specify a number of copies of the printable item to print-mail (e.g., if a user wants to mail multiple copies of a document to a recipient). Further, a print window may additionally include options 708 to enable a user to indicate how many pages should be included on each print-mailed sheet and/or to perform scaling.

A user may then select a page element, such as “Properties” button 710 or “OK” button 712, to cause the client device to produce additional prompts related to a print-mail process. For example, in an embodiment, selection of “Properties” button 710 may cause the print-mail application to produce one or more display windows that include prompts for printing properties, which include options for specifying how a printable item should ultimately be printed out at a destination print distribution center (e.g., center 120, FIG. 1). These properties may include, for example but not by way of limitation, paper size (e.g., letter, legal, or other), paper orientation (e.g., portrait or landscape), output color (e.g., black & white or color), paper source, page order, and pages per sheet, among other things. In other embodiment, some or all of these properties options may be specifiable from other windows, and/or more, fewer or different properties options may be provided.

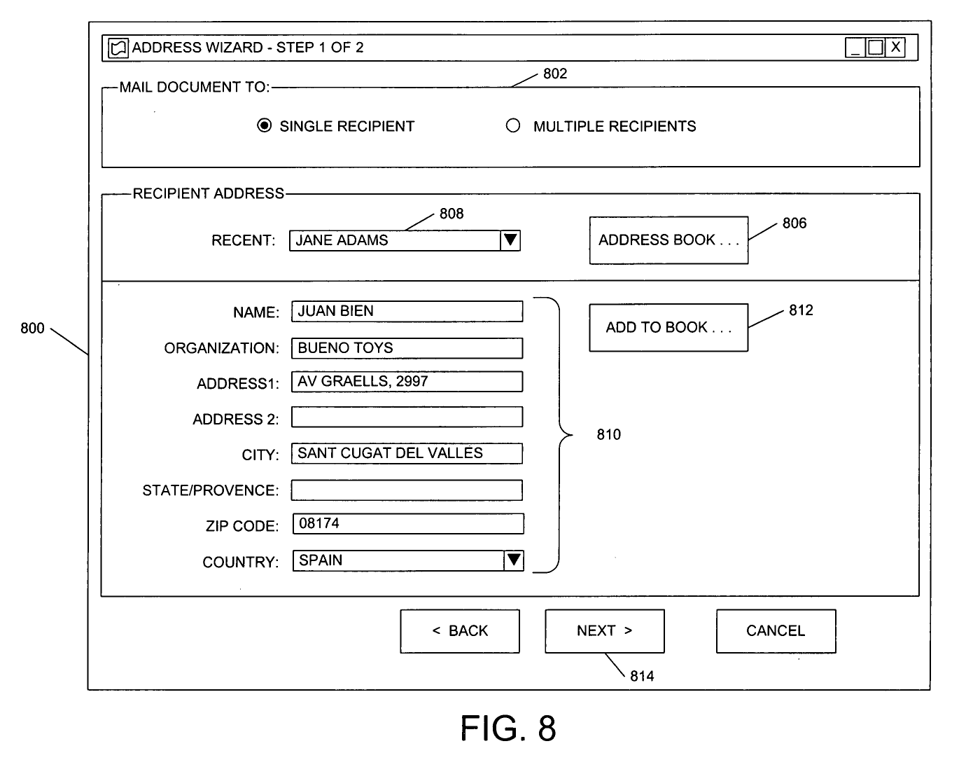

Selection of “OK” button 712 may cause the print-mail application to produce one or more display windows that include prompts for additional print-mail related information. In an embodiment, a next window to be displayed may include elements for specifying a destination address, among other things. FIG. 8 is an example of a display window 800, which enables a user to specify destination address, in accordance with an example embodiment.

In an embodiment, display window 800 may include options 802, which enable the user to indicate whether he or she would like the printable item to be print-mailed to a single recipient or multiple recipients. If multiple recipients are selected, then the user may be given the opportunity to enter or select one or multiple recipient addresses from one or more address lists or books.

Display window 800 may further include recipient address elements 804, which enable the user to enter or import recipient name, organization, and address information. In an embodiment, one or more recipient addresses or lists of addresses may be imported, for example, by selecting an “address book” element 806. Selection of the “address book” element 806 may cause a list of selectable recipient identifiers to be displayed, and/or may provide a search tool for locating an address within the user's address book. In an embodiment, a user may also be given the option of selecting a recently used recipient address, for example, by the recipient selecting a recipient name from a drop-down list of names provided in element 808.

Alternatively, a user may manually enter a recipient name and address information into elements 810. A user may also cause the manually entered information to be added to an address book or list by selecting “Add to Book . . . ” element 812.

When the user has completed the process of specifying one or more recipient addresses, he or she may select the “Next” button 814. In an embodiment, this Selection of “Next” button 814 may cause the print-mail application to produce one or more display windows that include prompts for additional print-mail related information. In an embodiment, a next window to be displayed may include elements for specifying a return address, among other things.

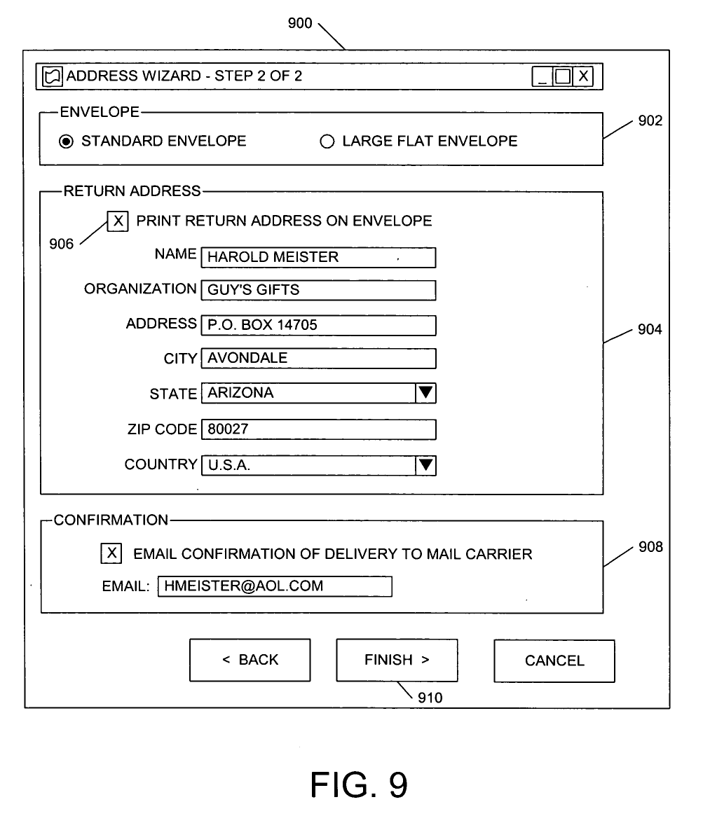

FIG. 9 is an example of a display window 900, which enables a user to specify return address and other print-mail options, in accordance with an example embodiment. In an embodiment, the display window 900 may include elements 902 to enable a user to indicate an envelope type. For example, a user may be able to specify that a standard envelope be used, which may result in the printed document being folded after it is printed. Alternatively, a user may be able to specify that a large envelope be used, which may eliminate folding the printed document. Although only two envelope options are illustrated, more options may be made available to the user.

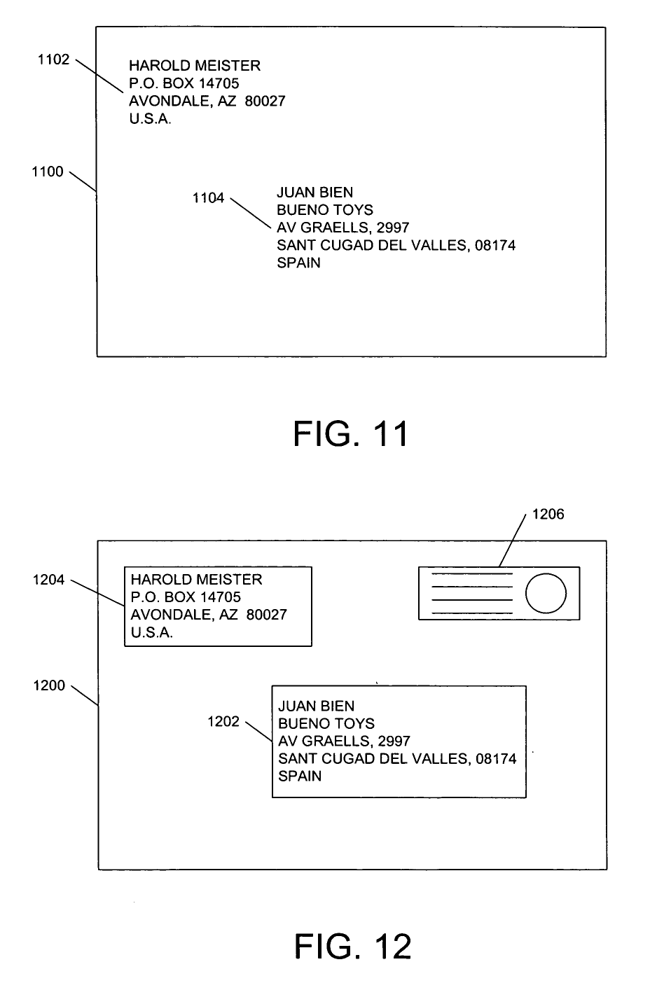

In an embodiment, display window 900 may also include elements 904 for specifying a return address. As will be described in more detail later, in an embodiment, a destination print distribution center may print an address sheet (e.g., address sheet 1100, FIG. 11), with a return address and/or a recipient address. The address sheet may have the various addresses positioned so that, when the sheet is inserted into a windowed envelope, the addresses are visible through the windows. The print distribution center may separately print the printable item, which may be inserted behind the address sheet. In an embodiment, a user may further be able to specify that the print distribution center alternatively should print the return address and/or the recipient address directly on the envelope. In such an embodiment, display window 900 may further include an option 906 that enables a user to print a return address on the envelope.

In an embodiment, display window 900 may further include an element 908, which enables a user to indicate whether he or she would like to receive a confirmation notice after the letter has been received by a destination print distribution center. A notice may be provided in any of several forms, including an email, a page, a postcard, a telephone call, or another form. In various other embodiments, a user may be provided with window options that enable him or her to indicate that he or she would like to receive a confirmation notice after completion of another stage of the process (e.g., after a printable item is printed and/or after a letter is received at the recipient address). For example, but not by way of limitation, a user may indicate that he or she would like to receive a delivery receipt upon successful delivery of the letter to the recipient address. In such an embodiment, the letter may be delivered from the receiving center using certified mail through the U.S. Postal Service. Other types of delivery confirmations may be provided by other carriers.

When the user is ready, he or she may select the “Finish” button 910. In an embodiment, this ultimately results in an electronic version of the printable item, along with the client-specified print-mail information, to be sent to a receiving center (e.g., receiving center 110, FIG. 1).

Referring back to FIG. 6, when the client device has received a user a user request to print-mail the printable item (e.g., by the user selecting the “Finish” button 910, FIG. 9), in block 608, then in block 610, the print-mail application may cause the client device to convert the printable item into another format and to store the converted printable item. In an embodiment, the printable item is converted into one or more image files (e.g., one image file for each printable page) and the files are temporarily stored, in an embodiment. For example, but not by way of limitation, a printable item may be converted into a file having a format selected from a group of formats that includes: Joint Photographic Experts Group (JPEG); tag image file format (TIFF); bitmap (BMP); graphics interchange format (GIF); portable network graphics (PNG); enhanced metafile (EMF); Windows metafile (WMF); Zsoft PC paintbrush bitmap (PCX); and others. In other embodiments, the print-mail application may convert the printable item into a non-image target format (e.g., Portable Document Format (PDF)) or the print-mail application may retain the printable item in the format of its source application (i.e., the application that created or opened the printable item). Although the latter embodiments are not discussed in detail, herein, it is to be understood that transmission through the print-mail system of a file in a format other than an image file format is intended to fall within the scope of the inventive subject matter.

In block 611, unless the user is already logged into the system, the user may be prompted for login information. In an embodiment, this may include the client device displaying a window, which includes elements into which the user may enter his or her Username and Password.

In block 612, the client device opens a network connection, and transmits the user's login information over the network to a receiving center (e.g., center 110, FIG. 1) or to another system server responsible for logging in a user. Alternatively, login of the user may occur at an earlier stage. If the user's login information is invalid, then the user is so informed, and may be given the opportunity to modify and re-send the login information.

The client device sends an “electronic version of the printable item” to a receiving center (e.g., center 110, FIG. 1) in block 614. The electronic version of the printable item includes, in an embodiment, the image file(s) into which the printable item was converted. In other embodiments, the electronic version of the printable item may include the original printable item, or the printable item converted into a format other than an image format.

In addition, in an embodiment, the client device sends the client-specified print-mail information to the receiving center. In an embodiment, the client-specified print-mail information may include some or all of the following information items: account ID, username, filename(s) (i.e., identifying the electronic version of the printable item), number of copies to print for each letter, paper size, paper orientation, envelope type, output print color, return address, return address print destination (e.g., envelope or cover sheet), recipient address(es), letter carrier selection, and confirmation information, among other things. The client-specified print-mail information may be sent as one or more text files or Extensible Markup Language (XML) files, for example, or it may be sent in another format or using a particular data transmission protocol.

A receiving center (e.g., center 110, FIG. 1) receives the image file and the client-specified print-mail information, in block 616. In an embodiment, in block 618, the receiving center determines, based on the client-specified print-mail information, one or more destination print distribution centers (e.g., centers 120, 122, 124, FIG. 1) to which the image file will be sent.

The receiving center may base this determination on one or more criteria. For example, for a given recipient address, the receiving center may select a print distribution center from which the least amount of postage will be required to deliver the letter. Alternatively, the receiving center may select a print distribution center from which the letter will likely be delivered to the recipient address in the least amount of time. The receiving center may take other criteria into account, as well, in making the decision, such as the capabilities, workload, maintenance problems, or other factors affecting the various available print distribution centers at a given time. Other criteria may alternatively or additionally be used to determine a destination print distribution center.

A determination of a destination print distribution center may be completely automatic, in an embodiment. In an alternate embodiment, a human “operator” having access to files and information received by the receiving center may be able to intervene in the decision-making process. For example, through a computer, an operator may be able to review a queue of received jobs and recipient address information, among other things, and specify a destination print distribution center. In another embodiment, the operator may be notified by the receiving center that a job has certain characteristics that warrant a human decision regarding a destination print distribution center. For example, if a destination address is in a country where no available print distribution center exists, or where current events make a particular print distribution center an unwise choice, then such an intervention may be warranted.

In an embodiment, an electronic version of the printable item and printing/delivery information (i.e., information based on the client-specified print-mail information), referred to herein as a “job,” is placed into a document queue, in block 619. If multiple recipient addresses were specified, then multiple jobs may be created, in an embodiment. For purposes of ease of description, the case of a singular recipient address is discussed herein.

When a job is placed in the document queue, the client device may be notified. The client device may then notify the user (e.g., by a pop-up message provided on the desktop) that a document exists in the document queue. The user may indicate that he or she would like to view the document queue, in an embodiment. For example, the client device may display a document queue icon on the desktop or within an open application toolbar, and the user may select the document queue icon. The system may then download the current document queue for viewing by the user.

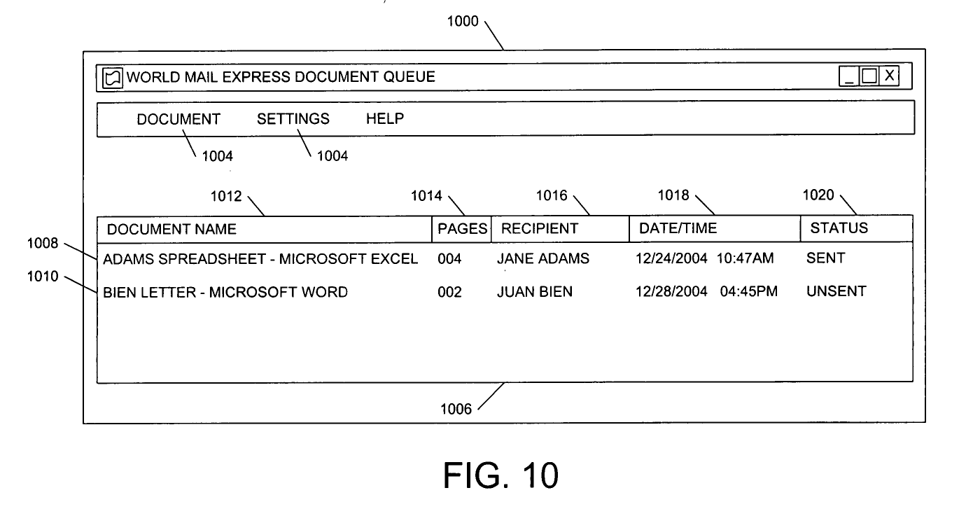

FIG. 10 illustrates a document queue 1000, in accordance with an example embodiment. Document queue 1000 includes one or more menu bar options 1002, 1004, and an element 1006 that may display information pertaining to one or more job records 1008, 1010 within the queue. In an embodiment, when a user selects the “Document” menu bar option 1002, the user may be provided with a drop-down list of selectable items. For example, the selectable items may include options to preview a document in the queue, to view recipient and/or return addresses for the document, to send a selected (e.g., highlighted), unsent document to a print distribution center, to send all unsent documents in the queue to their respective print distribution centers, to cancel a document upload that is in progress, and/or to delete a document from the queue. More, fewer or different options may be included, in other embodiments.

In an embodiment, each job record 1008, 1010 may include a document name field 1012, a page number field 1014, a recipient field 1016, a date field 1018, and a status field 1020. More, fewer or different fields may be included in other embodiments. The document name field 1012 for a record may identify the document. For example, the document identity may be the filename for the original document. In an embodiment, field 1012 may also indicate the originating application (e.g., Microsoft Word, Excel, Power Point, Corel Word Perfect, etc.). The page number field 1014 for a record may indicate the number of pages within the document. The recipient field 1016 for a record may indicate the name or identity of the recipient for the particular job. The date field 1018 may indicate the date that the document was received in the queue. Finally, the status field 1020 may indicate the current status of the document. For example, a status may indicate that a document is “uploading,” “unsent,” “sending,” or “sent.” Other status types may be indicated in other embodiments.

In an embodiment, when a user selects the “Settings” menu bar option 1004, the user may be provided with another drop-down list of selectable items. For example, the selectable items may include options to specify queue-related preferences, and/or a login option. When the login option is selected, the user may be prompted for Username and Password information, so that the user may login to the system. When the queue-related preferences option is selected, the user may be provided an option to specify, for example, whether or not to send documents automatically as they are printed at a print distribution center. A user may also be provided an option to specify, for example, whether or not the system should delete documents from the document queue automatically after they are sent to a print distribution center. More, fewer or different options may be provided in other embodiments.

Through the document queue window, a user may indicate that he or she would like an unsent document within the document queue to be sent to a print distribution center, in an embodiment. Referring back to FIG. 6, when the user has indicated that he or she would like a document within the document queue to be sent, the receiving center sends the electronic version of the printable item and the client-specified print-mail information (i.e., the job) to the selected print distribution center or centers, in block 620. In an embodiment, the electronic version of the printable item and the client-specified print-mail information are sent to the print distribution center(s) in the same format in which they were received by the receiving center. In alternate embodiments, either or both the electronic version of the printable item or the client-specified print-mail information may be reformatted and/or repackaged prior to sending them to the print distribution center(s).

A print distribution center (e.g., center 120, 122, 124, FIG. 1) receives the electronic version of the printable item and printing/delivery information, in block 622. In an embodiment, the print distribution center evaluates the printing/delivery information to determine whether to print the return address (if any) and/or the recipient address directly on an envelope or on a cover sheet. The print distribution center then prints the return address (if any) and the recipient address, accordingly, in block 624.

In an embodiment, both the return address and the recipient address are printed on a cover sheet in locations where, when the sheet is inserted into the appropriate envelope, the addresses will be visible through envelope windows. In another embodiment, both the return address (if any) and the recipient address are printed directly on an envelope. In still another embodiment, either the return address or the recipient address is printed on a cover sheet, and the other address is printed on the envelope. The print distribution center may further prepare an envelope by printing routing bar codes on the envelope, in an embodiment, or by printing the bar codes on a sticker to be applied to the envelope.

FIG. 11 is an example of a printed address cover sheet 1100, in accordance with an example embodiment. Cover sheet 1100 may include a return address 1102 printed in a first area, and a recipient address 1104 printed in a second area. As mentioned previously, in an embodiment, the addresses are printed in locations, on sheet 1100, which correspond to window locations for the selected envelope.

Referring back to FIG. 6, a copy of the electronic version of the printable item (e.g., the image file(s)) is also printed, in block 626. If a user previously specified that multiple copies be sent in a letter, then multiple copies are printed. In an embodiment where the electronic version includes one or more image files, then the print distribution center may print the image file(s) using an appropriate image viewing application (e.g., Windows Picture and Fax Viewer or another file-compatible application) or by using the print distribution center print queue module. In an embodiment where the electronic version of the printable item is in a non-image format, then the print distribution center may print the file using an application in which the file was created or in which the file may be opened.

In block 628, the address cover sheet (if any) and the printed copy (or copies) of the printable item are collated, folded (if necessary), and inserted into the selected envelope. The envelope may then be sealed.

In an embodiment, postage may then be determined and applied to the envelope, in block 630. For example, the envelope may be weighed, and the postage may be determined according to the rates for the letter carrier designated to deliver the letter. Postage also may be affected by the recipient's address, among other things. Postage may be applied by printing the postage on the envelope, printing the postage on a sticker and placing the sticker on the envelope, or placing an appropriate number of stamps on the envelope, in various embodiments. At that point, the letter may be ready-to-mail.

FIG. 12 is an example of a ready-to-mail letter 1200, in accordance with an example embodiment. When viewed from the outside, letter 1200 may include a recipient address and/or return address, which are visible through windows 1202, 1204, respectively. Alternatively, either or both of the addresses may be printed directly on the envelope. Further, letter 1200 may include an appropriate amount of postage 1206. Letter 1200 may also include a bar code (not illustrated) and/or other printed messages (e.g., “Urgent,” “Personal and Confidential,” or the like), as well.

Referring again to FIG. 6, in block 632, the letter is then sorted, if necessary, and output to an appropriate bin. For example, urgent delivery letters may be sorted from non-urgent delivery letters. Alternatively, letters may be sorted according to a designated letter carrier. Further, letters may be sorted according to delivery area. In still another embodiment, letters may not automatically be sorted.

In an embodiment, a print distribution center may identify a letter carrier. In alternate embodiments, another component of the system (e.g., a receiving center) may identify a letter carrier, or the letter carrier may be specified by the user. The print distribution center may identify a letter carrier, in an embodiment, based on various criteria (e.g., available carriers, cost, speed of delivery, carrier territory, etc.). A letter carrier is an organization or company capable of picking up a letter (e.g., at a print distribution center or other collection site), and physically carrying the letter to a recipient address. A letter carrier may be a government-supported postal service (e.g., the U.S. Postal Service), a private company (e.g., UPS or Federal Express), or another carrier.

In an embodiment, upon successful completion of a job, a print distribution center (e.g., centers 120, 122, 124, FIG. 1) may send a “job completed” message to the receiving center (e.g., center 110, FIG. 1), in block 634. The “job completed” message may include various information, such as a job transaction number (to identify the job), the postage required to send the letter, and other information. If requested by the client device, the receiving center may send confirmation of the completed job to the user (e.g., via email or another notification method).

The receiving center may additionally update billing information for the account, in block 636. For example, the receiving center may add a billing entry to the account that includes the postage and a transaction fee. In an embodiment, an account is billed on a monthly or other periodic basis, and the periodic billings may include all billing entries that accumulated for the account during the billing cycle. After updating the billing information for the account, the method ends.

The various procedures described herein can be implemented in hardware, firmware or software. A software implementation could use microcode, assembly language code, or a higher-level language code. The code may be stored on one or more volatile or non-volatile computer-readable media during execution or at other times. These computer-readable media may include hard disks, removable magnetic disks, removable optical disks, magnetic cassettes, flash memory cards, digital video disks, Bernoulli cartridges, RAMs, ROMs, and the like.

Although the Figures illustrate various processes as occurring in specific sequences, it would be apparent to one of skill in the art that the orders of the process blocks could be modified while still achieving the same results. Accordingly, modifications in the sequences of processing blocks are intended to fall within the scope of the inventive subject matter.

Thus, various embodiments of a mail distribution method, apparatus, and system have been described. The foregoing description of specific embodiments reveals the general nature of the inventive subject matter sufficiently that others can, by applying current knowledge, readily modify and/or adapt it for various applications without departing from the general concept. Therefore, such adaptations and modifications are within the meaning and range of equivalents of the disclosed embodiments.

The phraseology or terminology employed herein is for the purpose of description and not of limitation. Accordingly, the inventive subject matter embraces all such alternatives, modifications, equivalents and variations as fall within the spirit and broad scope of the appended claims.

What is claimed is:

1. A method comprising:
executing a print-mail application, on a client device, to perform a print-mail process for a printable item that is selectable by the client device;
prompting a user of the client device for client-specified print-mail information, wherein the client-specified print-mail information includes recipient address information, which indicates one or more physical recipient address;
sending an electronic version of the printable item and the client-specified print-mail information over a network to a receiving center;
the receiving center determining one or more destination print distribution centers based on the recipient address information;
the receiving center sending the electronic version of the printable item to the one or more destination print distribution centers; and
a destination print distribution center printing a copy of the printable item.

2. The method of claim 1, further comprising:
converting the printable item into one or more image files, wherein the electronic version of the printable item includes the one or more image files.

3. A method comprising:
executing a print-mail application, on a client device, to perform a print-mail process for a printable item that is selected or open on the client device;
prompting a user of the client device for client-specified print-mail information, wherein the client-specified print-mail information includes recipient address information that indicates one or more physical address; and
sending an electronic version of the printable item and the client-specified print-mail information over a network to a receiving center, to enable the receiving center to determine one or more destination print distribution centers, based on the recipient address information, to which the electronic version of the printable information should be routed for printing and physical delivery.

4. The method of claim 3, further comprising:
receiving an indication from the user that the user wants to perform the print-mail process for the printable item, wherein the indication includes an indication that the user has selected an option on the client device to print the printable item, and wherein the print-mail application includes a print-mail printer driver.

5. The method of claim 3, further comprising:
converting the printable item into one or more image files, wherein the electronic version of the printable item includes the one or more image files.

6. The method of claim 3, wherein prompting the user for the client-specified print-mail information includes prompting the user for an envelope type, a return address, and a recipient address.

7. A method comprising:
a receiving center receiving, over a network from a client device, an electronic version of a printable item and client-specified print-mail information, wherein the client-specified print-mail information includes recipient address information that indicates one or more physical addresses;
the receiving center determining one or more destination print distribution centers based on the recipient address information; and
the receiving center sending the electronic version of the printable item to the one or more destination print distribution centers to print and provide for delivery.

8. The method of claim 7, further comprising:
the receiving center determining a destination print distribution center as a destination print distribution center that is in a closest proximity to a recipient address.

9. The method of claim 7, further comprising:
the receiving center determining a destination print distribution center as a destination print distribution center that will require a least amount of postage to deliver a letter containing the copy to a recipient address.

10. The method of claim 7, further comprising:
the receiving center providing a document queue to the client device; and
the receiving center sending the electronic version of the printable item to the one or more destination print distribution centers in response to a user indication made through interaction with the document queue.

11. A method comprising:
a destination print distribution center receiving, over a network from a receiving center, printing/distribution information and an electronic version of a printable item which originated from a client device, wherein the printing/distribution information includes a physical recipient address;
printing a copy of the printable item and an address cover sheet that includes the physical recipient address;
collating the address cover sheet and the copy; and
inserting the address cover sheet and the copy into an envelope so that the physical recipient address is visible through an envelope window.

12. The method of claim 11, wherein the electronic version of a printable item includes one or more image files.

13. The method of claim 11, further comprising:
folding the copy and the address cover sheet prior to insertion into the envelope.

14. The method of claim 11, further comprising:
determining and applying postage to the envelope.

15. A method comprising:
a destination print distribution center receiving, over a network from a receiving center, printing/distribution information and an electronic version of a printable item which originated from a client device, wherein the printing/distribution information includes a physical recipient address;
printing a copy of the printable item;
printing the physical recipient address information on an envelope; and
inserting the copy into the envelope.

16. A method comprising:
a destination print distribution center receiving, over a network from a receiving center, printing/distribution information and one or more image files, which represent a converted version of a printable item that originated from a client device, wherein the printing/distribution information includes a physical recipient address;
printing a copy of the printable item; and
inserting the copy into an envelope for physical mailing to the physical recipient address.

17. The method of claim 16, further comprising:
printing an address cover sheet that includes the physical recipient address;
collating the address cover sheet and the copy; and
inserting the address cover sheet with the copy into the envelope so that the physical recipient address is visible through an envelope window.

18. The method of claim 16, further comprising:
printing the physical recipient address onto the envelope; and
inserting the copy into the envelope.

19. A computer readable medium having program instructions stored thereon to perform a method, which when executed result in:
executing a print-mail application, on a client device, to perform a print-mail process for a printable item that is selected or open on the client device;
prompting a user of the client device for client-specified print-mail information, wherein the client-specified print-mail information includes recipient address information that indicates one or more physical address; and
sending an electronic version of the printable item and the client-specified print-mail information over a network to a receiving center, to enable the receiving center to determine one or more destination print distribution centers, based on the recipient address information, to which the electronic version of the printable information should be routed for printing and physical delivery.

20. The computer readable medium of claim 19, wherein executing the program instructions further results in:
converting the printable item into one or more image files, wherein the electronic version of the printable item includes the one or more image files.

21. An apparatus comprising:
one or more network interfaces to receive, over a network from a client device, an electronic version of a printable item and client-specified print-mail information, wherein the client-specified print-mail information includes recipient address information that indicates one or more physical addresses, and further to send the electronic version of the printable item to one or more destination print distribution centers to print and provide for delivery; and
one or more processors, operatively coupled to the one or more network interfaces, to determine the one or more destination print distribution centers based on the recipient address information.

22. The apparatus of claim 21, further comprising:
a database, operatively coupled to the one or more processors, to store print-mail system account information.

23. An apparatus comprising:
a network interface to receive, over a network from a receiving center, printing/distribution information and an electronic version of a printable item which originated from a client device, wherein the printing/distribution information includes a physical recipient address;
a printer to print a copy of the printable item and an address cover sheet that includes the physical recipient address;
a collation mechanism to collate the address cover sheet and the copy; and
a mechanism to insert the address cover sheet and the copy into an envelope so that the physical recipient address is visible through an envelope window.

24. The apparatus of claim 23, further comprising:
a mechanism to fold the copy.

25. The apparatus of claim 23, further comprising:
a mechanism to determine and apply postage to the envelope.

26. An apparatus comprising:
a network interface to receive, over a network from a receiving center, printing/distribution information and an electronic version of a printable item which originated from a client device, wherein the printing/distribution information includes a physical recipient address;
a printer to print a copy of the printable item;
a printer to print the physical recipient address onto an envelope; and
a mechanism to insert the copy into the envelope.
